(19) United States
(12) Patent Application Publication
(10) Pub. No.: US 2016/0210216 A1
(43) Pub. Date: Jul. 21, 2016

(54) Application Control Flow Models

(71) Applicant: HEWLETT PACKARD ENTERPRISE DEVELEPMENT LP, Houston, TX (US)

(72) Inventors: Brian Quentin Monahan, Bristol (GB); Nigel Edwards, Bristol (GB); Mike Wray, Bristol (GB)

(21) Appl. No.: 14/914,098

(22) PCT Filed: Sep. 27, 2013
(86) PCT No.: PCT/US2013/062168

§ 371 Date: Feb. 24, 2016

(51) Int. Cl. G06F 11/36; G06F 9/44; G06F 9/45

(52) U.S. Cl. CPC G06F 11/3604; G06F 8/433; G06F 8/75

(57) ABSTRACT

In one implementation, a processor-readable medium stores code representing instructions that when executed at a processor cause the processor to access a source-code representation of an application, to access a machine-code representation of the application, and to generate a control flow model of the application based on the source-code representation of the application. The processor-readable medium also stores code representing instructions that when executed at the processor cause the processor to store a representation of the control flow model within a file including the machine-code representation of the application.

### BACKGROUND

Application monitoring systems monitor or observe execution of applications hosted at computing systems. Such application monitoring systems can be useful to determine whether an application is functioning and/or functioning in a manner that suggests that the application is functioning erratically,

Some application monitoring systems analyze bytecode or machine-code representations of applications to identify monitorable sections of those applications. For example, an application monitoring system can parse a bytecode or machine-code representation of an application to identify sections of the application (e.g., sequences of instructions encoded in bytecode or machine-code) that may be instrumented to allow run-time monitoring of the application without causing malfunction of the application.

### BRIEF DESCRIPTION OF THE DRAWINGS

FIG. 1 is a flowchart of an application monitoring process, according to an implementation.

FIG. 2 is an illustration of an application hosted via a hypervisor within a host operating system, according to an implementation.

FIG. 3 is an illustration of a file for application monitoring, according to an implementation.

FIG. 4 is a schematic block diagram of an application monitoring system, according to an implementation.

FIG. 5 is a schematic block diagram of a computing system hosting an application monitoring system, according to an implementation.

FIG. 6 is an illustration of generation of a file for application monitoring, according to an implementation.

### DETAILED DESCRIPTION

Although some application monitoring systems analyze bytecode or machine-code representations of applications to determine control flow information about those application and identify monitorable sections of those applications, extracting control flow information from bytecode and machine-code representations can be a difficult and inefficient task. Extraction of control flow information from machine-code representations is typically a particularly difficult task. As a particular example, extraction of control flow information from binary executable files is complex, leading to a high likelihood of error and resource utilization.

Source-code representations of applications describe or define applications in programming languages. Typically, the programming languages of source-code representations are human-readable and include information about the functionalities (e.g., structures and flows such as data flow and control flow) that allow efficient and accurate derivation of control flow graphs of those applications. A control flow graph is a description of the intended flow of an application among sections of the application during execution.

However, application developers or distributors generally need not distribute applications as source-code representations. A common reason for this is to protect the IP surrounding the software and prevent details about internal workings of those applications from becoming known to competitors. Rather, application developers typically distribute applications as executable files including bytecode or machine-code representations of the applications that are derived or compiled from source-code representations of the applications.

Files (e.g., sequences of bytes stored at non-transitory processor readable media) that include a bytecode representation or a machine-code representation of an application are often referred to as executable files because these files can be executed at a computing system to cause the computing system (or a processor thereof) to perform actions. Additionally, files that include a machine-code representation of an application are often referred to as binary executable files because a machine-code representation of an application includes instructions that are encoded as a sequence of binary values (e.g., ones and zeros) that are executed by a processor. Applications are often distributed (or delivered) as a group of related binary executable files that may include shared executable files such as shared or dynamically linked libraries. Such files are often referred to as modules (or binary modules) or objects (or binary objects).

Some developers of applications incorporate monitoring interfaces into the applications. Such monitoring interfaces are provided entirely at the discretion of the developers of the applications. However, organizations using applications may desire to monitor these applications according to policy requirements of those organizations. Often, the monitoring desired by such organizations is not supported by any of the monitoring interfaces or capabilities provided by the developers of these applications. Accordingly, providing additional monitoring capabilities to applications by the organizations using those applications can be helpful to those organizations.

Such additional monitoring capabilities should, however, be provided in a manner that does not disrupt operational functionalities of such applications. Monitoring execution of an application (or application monitoring) to determine whether an application is functioning and/or functioning properly (i.e., as it was designed to function) is complicated by the absence of explicit information about the intended function of the application within the representation of the application in which the application is distributed. In other words, application monitoring is complicated because determining the intended functionality of an application can be quite difficult due to the representation in which that application is distributed. Depending upon the implementation technology used (e.g. Java®, .Net®) it may be tractable to analyze the representation of an application that is executed (or interpreted) to attempt to derive a sufficiently detailed and accurate control flow graph of the application to determine the intended function of the application. However, such analysis is not generally possible for applications unless additional information is made available about the application's internal structure and functionalities (e.g., the applications control and/or data flow).

For example, an application can be represented in a bytecode representation or a machine-code representation. Typically, a bytecode representation of an application is a collection of instructions that are executed at an interpreter such as a virtual machine to realize or implement an application. As a specific example, bytecode representations of applications can be derived from source code representations of those applications written in programming languages targeting the Java® run-time environment (e.g., Java® virtual machine), the Microsoft .Net® run-time environment (e.g., an interpreter of the Common Intermediate Language), or using the LLVM (Low-Level Virtual Machine) bit-code technology. Some such bytecode representations of applications include sufficient information about the structure and flow of those applications for efficient and accurate derivation of a control flow graph from the bytecode representations. However, such derivation can be resource intensive, slow, and error prone.

Typically, some classes of applications such as systems level applications are not written using such programming languages because they generally rely on sophisticated run-time support services (e.g. garbage collection) that are not typically available at the lower-level, more foundational components within a computing system (e.g., an operating system hosted at a computing system). Additionally, high performance software typically needs to be written using systems-level software to provide efficient access to machine level services.

Many such applications are distributed as machine-code representations of those applications. A machine-code representation is a set of instructions executed by a processor such as a central processing unit (CPU) or a computing system. Typically, each instruction performs a specific task and is native to a particular processor or processor architecture. As specific examples, a machine-code representation can include instructions native to an ARM® processor architecture, an x86 processor architecture, or an x86-64 processor architecture. Typically, such machine-code representations are derived or compiled from system programming languages such a C or C++, and do not include sufficient information about the structure and flow of those applications for efficient or accurate derivation of a control flow graph from the machine-code representations. Accordingly, the control flow graphs that are derived from such representations are generally the results of resource-intensive (e.g., requiring extensive computing resources), and approximation-driven analysis. Unfortunately, this means the control flow graphs resulting from such analysis are generally too imprecise for accurately identifying monitorable sections of applications at which to instrument (e.g., place monitoring code) or otherwise monitor applications. As a result, application monitoring based on such control flow graphs either fails to capture the intended information sufficiently and/or risks damaging the application's functional integrity, making the application much less stable and reliable and far more error-prone in operation.

Implementations discussed herein are directed to distributing information related to the intended function of applications together with representations of those applications. For example, some implementations discussed herein describe systems, methods, and apparatus to include a control flow model within an executable file including a representation of an application. As another example, some implementations discussed herein describe systems, methods, and apparatus to identify a control flow model with an executable file including a representation of an application extended with an annotated representation of the application with the objective of identifying monitorable sections of that application. Accordingly, such implementations can enable accurate and efficient application monitoring by allowing developers or distributors of application to export or provide relevant information to enable application monitoring without disclosing source-code representations of applications.

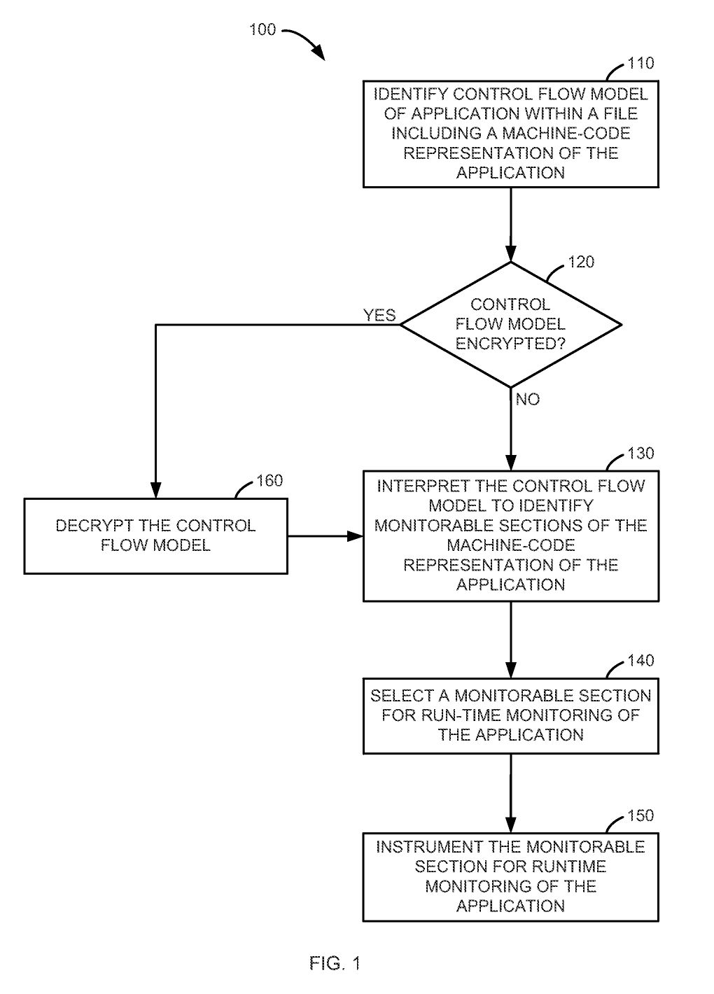

As one example, FIG. 1 is a flowchart of an application monitoring process, according to an implementation. Process 100 can be implemented within a variety of environments. As a specific example, process 100 can be implemented at a computing system hosting an application monitoring system. As another specific example, process 100 can be implemented by instructions stored at a non-transitory processor-readable medium that cause a processor to perform the blocks or steps of process 100 when executed at the processor. Additionally, references herein to a process such as process 100 performing some action should be interpreted to mean that a computing system; a processor or other component of a computing system such as a processor executing or interpreting instructions stored at a non-transitory processor-readable medium; or a combination of components, instructions stored at a non-transitory processor-readable medium, and/or computing systems perform those actions.

Furthermore, process 100 illustrated in FIG. 1 is an example, application monitoring process. In other implementations, other application monitoring processes can include additional, different, or rearranged blocks or steps than those illustrated in FIG. 1. Some examples of such implementations are discussed in relation to FIG. 1.

A control flow model (or a representation thereof) of an application is identified within a file including a machine-code representation of the application at block 110. As a specific example, process 100 can identify the control flow model of an application in the file including the machine-code representation of the application before the machine-code representation of the application is loaded into a memory of a computing device. A control flow model of an application is a description of the intended function of that application or a portion thereof. Because the control flow model is explicitly included with the machine-code representation, an application monitoring system can determine the intended functionality of the application without attempting to derive such information from the machine-code representation. In other words, a control flow model provides an appropriately detailed map of an application that can be used to enable application monitoring such as dynamic run-time analysis of the application.

Moreover, in some implementations, the control flow model excludes or obfuscates information about the functionality of sensitive sections of the application (e.g., sections of the application about which a developer or distributor of the application desires not to provide a description of functionality or flow). For example, a group of basic blocks of the application (e.g., a basic block of the machine-code representation of the application) through which flow of the application during execution converges upon another basic block can be represented by a single node or fewer nodes than the number of basic blocks in that group of basic block to obfuscate or exclude information about the functionality of those sections (e.g., basic blocks) of the application. Furthermore, in some implementations, a control flow model of an application includes references to sections of a machine-code representation of that application within an executable file including the control flow model and the machine-code representation.

The control flow model can be, for example, derived from a source-code representation of the application, which is not included in the file including the control flow model and the machine-code representation of the application. As a specific example, a developer or distributor of the application can derive the control flow model from a source-code representation of the application and include a representation of the control flow model in the file including the machine-code representation of the application. Thus, the developer or distributor of the application can provide information about the functionality of the application without providing access to the source-code representation of the application. Moreover, as discussed above, the control flow model can exclude or obfuscate a description of the functionality of sensitive sections of the application. Accordingly, the developer or distributor of the application can exclude or obfuscate a description of the functionality of sensitive sections of the application.

As a specific example, a control flow model can be represented as a control flow graph. A control flow graph is a representation of the potential flow (or flows) of an application in graph notation. In other words, a control flow graph describes paths through or relationships among sections of a representation (e.g., a machine-code representation) of an application. Such sections can be basic blocks (i.e., sections of the application that do not include jumps, branches, or targets (e.g., jump or branch targets)) of the representation of the application. The basic blocks can be represented as nodes of the control flow graph and the edges of the control flow graph connecting the nodes can represent potential flow of execution of the application through the basic blocks (e.g., potential execution paths of the application). In some implementations, each node of the control flow graph can reference (e.g., include a byte offset of or pointer to) the section of the machine-code representation of an application associated with or represented by that node within an executable file including the control flow graph and the machine-code representation of that application.

Process 100 can identify the control flow model of the application with the file including the machine-code representation of the application by identifying a pointer to the control flow model at a predetermined or standard byte offset within the file including the machine-code representation of the application. As another example, process 100 can identify the control flow model of the application within the file including the machine-code representation of the application by identifying a section or portion of the file including the machine-code representation of the application. As a specific example, such a section or portion of the file can be a segment or section of an Executable and Linkable Format (ELF) executable file (or the PE/COFF format for the Microsoft Windows® environment). Such a segment or section of an executable file (of a given format of executable file) can be an additional or custom segment or section with respect to presently defined segments and sections.

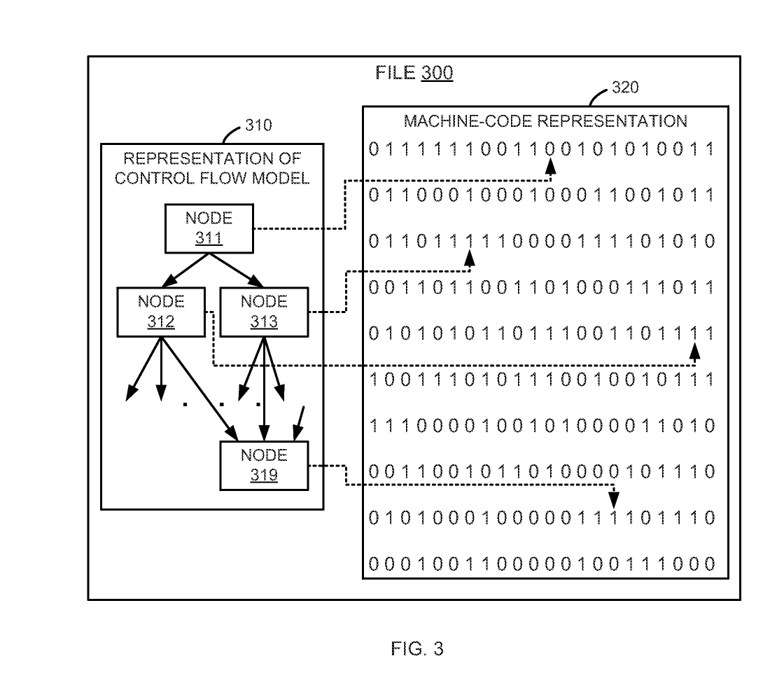

For example, FIG. 3 is an illustration of a file for application monitoring, according to an implementation. File 300 can be an executable file of an application such as, for example, a binary executable file of an application. As illustrated in FIG. 3, file 300 includes representation of control flow model 310 and machine-code representation 320. Representation of control flow model 310 describes intended or programmed functionality (e.g., control flow) of the application defined by machine-code representation 320. Control flow model 310 and machine-code representation 320 can be located, for example, at predetermined sections or segments of file 300. Moreover, in the example illustrated in FIG. 3, control flow model 310 and machine-code representation 320 are separate one from another within file 300. In other words, control flow model 310 is not included within or implicit to machine-code representation 320.

As illustrated in FIG. 3, representation of control flow model 310 is a control flow graph with nodes (only a portion of which are explicitly shown and discussed herein in relation to FIG. 3) that represent sections (e.g., basic blocks) of machine-code representation 320. That is, the edges of the control flow graph describe the flow of the application defined by machine-code representation 320 among the sections of machine-code representation 320 and represented by nodes 312, 312, 313, 319, and other nodes of the control flow graph not explicitly illustrated. More specifically, the section of the application defined by the instructions referenced or pointed to by node 311 ends with a conditional jump or branch to either the section of the application defined by the instructions referenced or pointed to by node 312 or the section of the application defined by the instructions referenced or pointed to by node 313.

Similarly, the section of the application defined by the instructions referenced or pointed to by node 312 ends with a conditional jump or branch to one of three other section of machine-code representation 320, one of which is the section of the application defined by the instructions referenced or pointed to by node 319. Additionally, the section of the application defined by the instructions referenced or pointed to by node 313 ends with a conditional jump or branch to one of three other section of machine-code representation 320, one of which is the section of the application defined by the instructions referenced or pointed to by node 319.

Referring again to FIG. 1, in some implementations, as illustrated in FIG. 1, a representation of a control flow model of an application can be encrypted within the file including the machine-code representation of the application. For example, the representation of the control flow model can be encrypted to limit access to the control flow model. That is, for example, a developer or distributor of an application may allow some parties or entities to access the control flow model by providing a cryptographic key to those parties. Such a key can be a symmetric cryptographic key, an asymmetric cryptographic key (e.g., a public key of a public/private key pair), or some other cryptographic key that can be used to decrypt the encrypted representation of the control flow model. Moreover, in some implementations, the file including the machine-code representation of the application can include a digital signature (e.g., a hash or digest value derived from the representation of the control flow model that is signed or encrypted) and/or digital certificate for the representation of the control flow model to allow the representation of the control flow model to be authenticated as provided by a particular source (e.g., the developer or distributor of the application).

At block 120, process 100 determines whether the representation of the control flow model is encrypted. If the representation of the control flow model is not encrypted, process 100 proceeds to block 130. If the representation of the control flow model is encrypted, process 100 proceeds to block 160 at which the representation of the control flow model is decrypted. For example, the representation of the control flow model is decrypted using a cryptographic key accessible to process 100. In some implementations, process 100 requests a cryptographic key in response to determining at block 120 that the representation of the control flow model is encrypted. For example, process 100 can request the cryptographic key from a service provided by the developer or distributor of the application and then decrypt the representation of the control flow model using the cryptographic key received in response to the request.

At block 130, the control flow model is interpreted at block 130 to identify monitorable sections of the application. Said differently, the control flow model is interpreted at block 130 to identify sections of the representation of the machine-readable representation of the application that can be instrumented (e.g., modified prior to execution or run-time) or observed to monitor the application. Monitorable sections of an application are sections of a representation of an application (e.g., sequences of machine-code instructions) that can be used to monitor functionality of an application. For example, sections of a representation of an application that can be instrumented (e.g., modified within a memory of a computing system with additional instructions) to facilitate application monitoring without causing the application to malfunction when executed at a processor are monitorable sections of the application. As another example, sections of a representation of an application that can be observed during execution or run-time of the application (e.g., sections of an application that perform particular operations, sections of an application that include instructions with results that can be readily observed, or sections of an application that are periodically executed) are monitorable sections of the application.

In the implementation illustrated in FIG. 1, a monitorable section for the monitorable sections of the application identified at block 130 is then selected at block 140. The monitorable section can be selected based on any of a variety of features, characteristics, biases, policy, or other considerations. For example, the monitorable section can be selected based on an ease or simplicity of instrumenting that monitorable section. More specifically, for example, some monitorable sections can be instrumented using fewer instructions (e.g., fewer modified or added instructions to a machine-code representation of an application) than other monitorable sections, and such a monitorable section can be selected.

As another example, an application monitoring system can include, access, or interpret one or more policies, and can select a monitorable section based on the one or more policies. Such policies can, for example, define a preference or bias for monitoring an application using monitorable sections that have predefined characteristics such as a particular instruction or type of instruction. As a specific example, an application monitoring system can select a monitorable section that is likely to be frequently executed based on the control flow model of the application.

In some implementations, as illustrated in FIG. 1, the monitorable section of the application (or of the machine-code representation of the application) selected at block 140 is instrumented at block 150 for run-time monitoring of the application. For example, the monitorable section of the machine-code representation of the application can be modified within a memory of a computing system hosting the application (i.e., that is or will execute the application). More specifically, for example, process 100 can add and/or modify instructions at the selected monitorable section of the machine-code representation of the application within a memory of a computing system to cause the application to cause status information, signals, or updates to be provided to an application monitoring system.

In other implementations, an application monitoring system can monitor execution of the application by observing effects or results of execution of the instruction within the selected monitorable section of the machine-code representation of the application. For example, the application monitoring system can observe the effects of the instructions of the selected monitorable section of the machine-code representation of the application within a computing system (e.g., based on register values of a processor, state changes of a processor, network communications, or other observable effects of executed instructions) to monitor execution of the selected monitorable section.

Traditional application monitoring systems have been a useful part of the professional systems management toolkit for many years, typically as a part of providing runtime enforcement of resource controls for applications. This generally involves the real-time monitoring of operating system resources as they are consumed, preventing applications accessing unauthorized resources or exceeding resource limits. In particular, such operating system monitoring relies upon generic operating system interfaces and does not require modifications such as instrumentation to the application itself.

However, detecting and countering modern malware threats often requires more invasive application monitoring. For example, increasing trends in attacks from modern malware (e.g., botnets, stealth-ware, ransom-ware, espionage and sabotage) exploit vulnerabilities to perform attacks via techniques such as process code insertion, pointer subterfuge, and return-oriented programming (e.g., jump-to-libc attacks) that can subvert or damage system operations to take control of a target system. Typically, application monitoring systems rely on continuous invasive application monitoring to ensure various integrity properties are enforced at runtime. Such continuous invasive application monitoring complicates balancing effective application monitoring and performance with achieving the desired level of security protection.

An application monitoring process such as process 100 can provide enhanced levels of security with reduced performance degradation. As a specific example, process 100 can be used in a control flow integrity (CFI) approach to application monitoring. That is, a CA approach to application monitoring can be implemented at blocks 130, 140, and 150 using the control flow information included within the file including a machine-code representation of the application.

CFI involves monitoring and/or checking various runtime integrity properties of an application that should be invariantly true of the control flow corresponding to the application during execution or run-time. A specific example of this kind of property is that each procedure (or function) call returns correctly to the instruction immediately following each corresponding procedure call (i.e. the return address for each procedure call is the next instruction after the call).

One particular implementation of CFI is referred to as an identifier check (or ID-check). A specific identifier (e.g., a 32-bit value) is stored at a specific register prior to a procedure call and then checked upon return from the procedure. If the comparison fails, an incorrect execution sequence has very likely been detected and an exception or failure condition should then be raised (typically an abort). A useful property of this implementation is that procedure calls and jumps involving indirect addressing (i.e., computed return or jump addresses) can also be handled. Additionally, it is possible for various identifier values needed for CFI checking to be embedded literally in the read-only code segment of an application (e.g., a read-only code segment of a machine-code representation of the application), complicating direct modification of the identifiers to circumvent the checking by malicious parties, application, or executing code.

CFI requires knowledge of the control flow an application to accurately identify monitorable sections and place sufficiently accurate instrumentation (e.g., code) to check about targets and origin of control transfers (e.g., procedure calls and jumps) to ensure integrity of control flow in the application. Because accurate control flow information is typically not accessible to parties hosting or executing applications, it is often necessary to instead rely upon dynamic runtime program analysis that interprets each and every machine instruction and can thus ensure that the CFI identification checks are performed by the monitoring system. This variant of CFI imposes a significant performance penalty related to essentially single-stepping through the untrusted application code. Using a process such as process 100 illustrated in FIG. 1, the control flow information included within the file including a machine-code representation of the application can be interpreted at block 130 to identify monitorable sections of the application and select one or more monitorable sections of the application at block 140 for instrumentation at block 150 as discussed below.

In this particular example, a shadow stack can be deployed to record the appropriate identifier values and corresponding return addresses for each procedure call. The shadow stack is a data structure that can then be used to extend CFI checking to ensure that the sequencing of calls is correctly maintained. Additionally, a further advantage of this approach is that the use of dynamically allocated structures such as a shadow stack extends the range of CFI checks that can be made. Typically, the shadow stack data structure should be placed into protected writable memory since a sufficiently capable attacker could interfere with the values put on the stack, thereby circumventing and nullifying the CFI checks.

One approach to protecting the shadow stack and also the dynamic runtime analysis checking is to rely on hardware virtualization technology supported by modern processors (e.g., Intel and AMD x86 family processors). However, this approach can result in significant performance degradations. For example, an application can be hosted within a guest operating system that is hosted via a hypervisor system such as QEMU executed by a separate host operating system. Procedure calls made by the application can be efficiently trapped in the guest operating system. Accordingly, the security of this approach depends upon the host operating system being sufficiently secured and subject to controlled updates. For example, this isolation policy would suggest that the host operating system should not be directly connected to an external network such as the Internet, whereas the guest operating system could be because of the protection afforded by the host operating system.

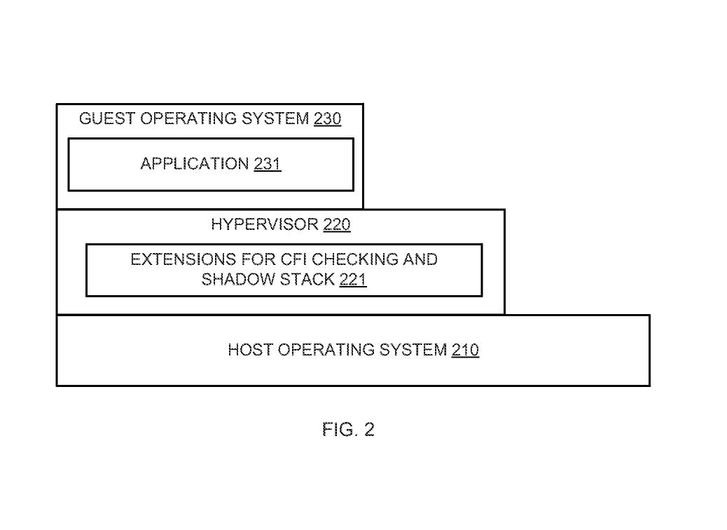

Another approach, the control flow information included within the file including a machine-code representation of the application can be used to extract the indirect call information from an execution of the application within the guest operating system. This information can then be used in an enforce mode which treats previously unseen indirect transfers as errors or threats. For example in the implementation illustrated in FIG. 2, CFI checking of application 231 run (or hosted or executed) in guest operating system 230 makes use of modified hypervisor system 220 which implements shadow stack 221 and is hosted within host operating system 210. In particular, the modified hypervisor 220 implements the shadow stack capability and enforces first-in/last-out usage of the shadow stack and CFI checking 221 such as return-to-caller checking (i.e., return to the instruction following a procedure call after execution of the procedure). Additionally, the return-to-caller functionality is configured to handle signals, longjmp, and other procedure call and return mechanisms.

Because detailed control flow information is included within the file including the machine-code representation of the application, the source and target code locations of procedure calls and jumps (i.e., monitorable sections) are available to the application monitoring section to enable CFI instrumentation (e.g., enable CFI checking code to be placed inline). The shadow stack can be implemented within a hypervisor to provide access restriction. For example, the application can be hosted within a guest operating system hosted via a hypervisor in a host operating system. Thus, the single stepping used in other implementations to locate procedure calls would not need to be performed dynamically. Accordingly, the CFI approach can have significantly improved performance.

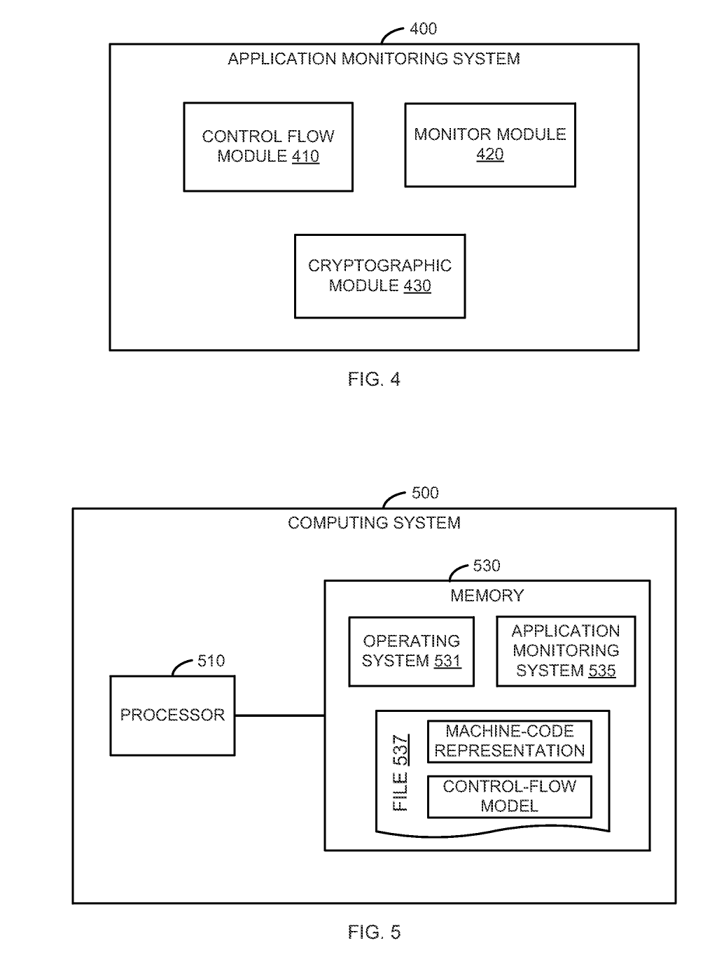

FIG. 4 is a schematic block diagram of an application monitoring system, according to an implementation. Application monitoring system 400 includes a group of modules that perform various functionalities of application monitoring system 400. As used herein, the term “module” refers to a combination of hardware (e.g., a processor such as an integrated circuit or other circuitry or a processor-readable medium) and software (e.g., machine- or processor-executable instructions, commands, or code such as firmware, programming, or object code). A combination of hardware and software includes hardware only (i.e., a hardware element with no software elements such as an ASIC), software hosted at hardware (e.g., software that is stored at a memory such as RAM, a hard-disk or solid-state drive, resistive memory, or optical media such as a DVD and/or executed or interpreted at a processor), or hardware and software hosted at hardware.

Although particular modules (i.e., combinations of hardware and software) are illustrated and discussed in relation to application monitoring system 400 specifically and other example implementations discussed herein generally, other combinations or sub-combinations of modules can be included within other implementations. Said differently, although modules illustrated in FIG. 4 and discussed in other example implementations perform specific functionalities in the examples discussed herein, these and other functionalities can be accomplished, implemented, or realized at different modules or at combinations of modules.

For example, two or more modules illustrated and/or discussed as separate can be combined into a module that performs the functionalities discussed in relation to the two modules. As another example, functionalities performed at one module as discussed in relation to these examples can be performed at a different module or different modules. Moreover, a module discussed herein in relation to a particular type of module can be implemented as a different type of module in other implementations. For example, a particular module can be implemented using a group of electronic and/or optical circuits (or circuitry) or as instructions stored at a non-transitory processor-readable medium such as a memory and executed at a processor.

As illustrated in FIG. 4, application monitoring system 400 includes control flow module 410, monitor module 420, and cryptographic module 430. Control flow module 410 is a combination of hardware and software that accesses a representation of a control flow model of an application within a file including a machine-code representation of the application. For example, control flow module 410 can perform functionalities discussed above in relation to FIG. 1 such as those discussed in reference to blocks 110 and 120 of process 100. Moreover, in some implementations, control flow module 410 interprets a control flow model to identify a group of monitorable sections of the machine-code representation of the application. As a specific example, control flow module 410 can implement block 130 of process 100.

Monitor module 420 is a combination of hardware and software that initiates run-time monitoring of the application based on the monitorable sections of the machine-code representation of the application. For example, monitor module 420 can select a monitorable section of the application as discussed above in relation to FIG. 1 to initiate run-time monitoring of the application. In some implementations, monitoring module 420 can instrument one or more monitorable sections of a machine-code representation of an application within a memory of a computing system to initiate monitoring of the application.

For example, monitor module 420 can add instructions or codes to or alter instructions or codes of the machine-code representation of an application within a memory of a computing system to instrument one or more monitorable sections of the application. As specific examples, monitor module 420 can add instructions to the machine-code representation of the application to implement one or more callbacks, heartbeats, or other traces within the application. That is, the added instructions can cause the application call procedures within or provide data or signals to a module such as monitoring module 420 to indicate at run-time which monitorable sections of the application are executed.

In other implementations, monitoring module 420 can configure one or more processes, threads, or modules to observe one or more monitorable sections of an application during run-time (or execution) of the application by sampling, reading, or otherwise observing effects of execution of the instruction in a machine-code representation of the application at a processor or memory of the computing system hosting the application to initiate monitoring of the application. Application monitoring system 400 can then rely on such instrumentation of machine-code representation of the application or observations of the effects of execution of the machine-code representation of the application for run-time monitoring of the application.

Cryptographic module 430 is a combination of hardware and software that decrypts encrypted representations of control flow models. That is, cryptographic module 430 can access cryptographic keys to decrypt representations of control flow models that are determined to be encrypted. In some implementations, cryptographic module 430 communicates (e.g., via a communication network) with one or more services to access or request the cryptographic keys cryptographic module 430 uses to decrypt encrypted representations of control flow models.

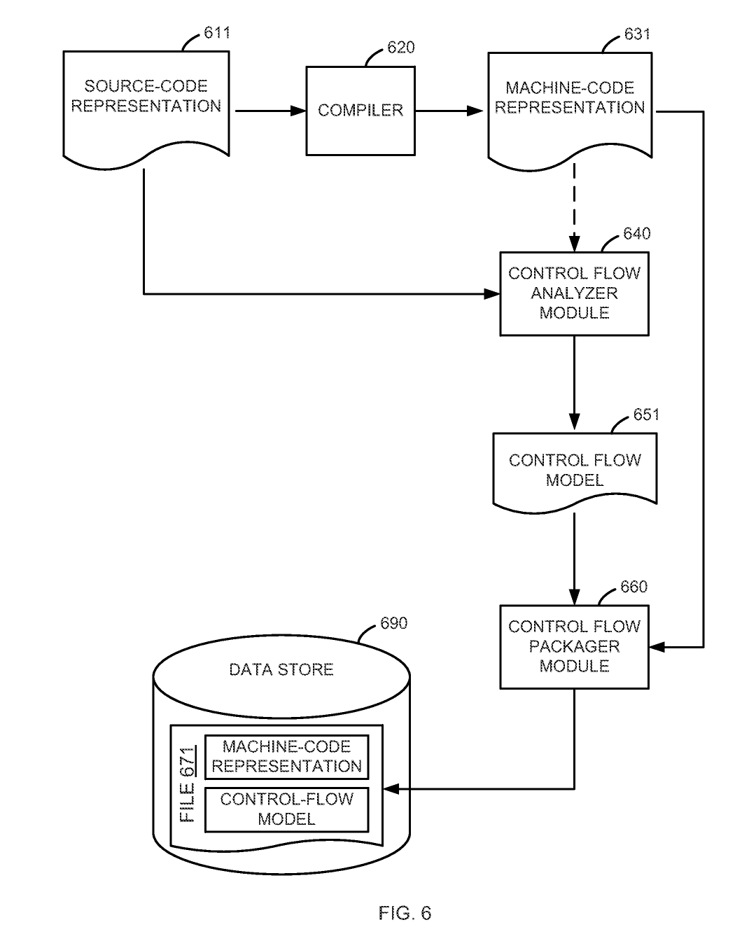

FIG. 5 is a schematic block diagram of a computing system hosting an application monitoring system, such as application monitoring system 400, according to an implementation. In the example illustrated in FIG. 5, computing system 500 includes processor 510 and memory 530. Computing system 500 can be, for example, a server, a notebook computing device, a tablet device, or some other computing device. In some implementations, a computing system hosting an application monitoring system is referred to itself as an application monitoring system.

Processor 510 is any combination of hardware and software that executes or interprets instructions, codes, or signals. For example, processor 510 can be a microprocessor, an application-specific integrated circuit (ASIC), a graphics processing unit (GPU) such as a general-purpose GPU (GPGPU), a distributed processor such as a cluster or network of processors or computing systems, a multi-core or multi-processor processor, a virtual or logical processor, or some combination thereof. As a specific example, in some implementations, processor 510 can include multiple processors such as one or more general purpose processors and one or more general-purpose GPUs.

Memory 530 is one or more processor-readable media that store instructions, codes, data, or other information. As used herein, a processor-readable medium is any medium that stores instructions, codes, data, or other information non-transitorily and is directly or indirectly accessible to a processor. Said differently, a processor-readable medium is a non-transitory medium at which a processor can access instructions, codes, data, or other information. For example, memory 530 can be a volatile random access memory (RAM), a persistent data store such as a hard-disk drive or a solid-state drive, a compact disc (CD), a digital versatile disc (DVD), a Secure Digital™ (SD) card, a MultiMediaCard (MMC) card, a CompactFlash™ (CF) card, or a combination thereof or of other memories. In other words, memory 530 can represent multiple processor-readable media. In some implementations, memory 530 (or some portion thereof) can be integrated with processor 510, separate from processor 510, or external to computing system 500.

Memory 530 includes instructions or codes that when executed at processor 510 implement operating system 531 and other modules such as components (or modules) of application monitoring system 535. In other words, instructions or codes stored at memory 530 can be referred to as modules. Memory 530 is also operable to store additional codes or instructions to implement other modules not illustrated in FIG. 5 and/or other data sets such as file 537. As specific examples, File 537 can be, for example, a file within a file system implemented at a non-volatile portion of memory 530.

In some implementations, computing system 500 can be a virtualized network device. For example, computing system 500 can be hosted as a virtual machine at a server computing device.

Application monitoring system 535 and/or file 537 can be accessed or installed at computing system 500 from a variety of memories or processor-readable media or via a communications network. For example, computing system 500 can access application monitoring system at a remote processor-readable medium via a communications interface (not shown). As a specific example, computing system 500 can be a network-boot device that accesses operating system 531 and components of application monitoring system 535 during a boot process (or sequence). Additionally, computing system 500 (or application monitoring system 535) can access file 537 including a machine-code representation and a representation of a control-flow model of an application via a communications interface (not shown). As yet another example, computing system 500 can include (not illustrated in FIG. 5) a processor-readable medium access device (e.g., a CD or DVD drive or a CF or SD card reader) to access a processor-readable medium storing components of application monitoring system 535 and/or file 537.

FIG. 6 is an illustration of generation of a file such as an executable file or binary executable file for application monitoring, according to an implementation. Such a file can be generated before an application is distributed. For example, a file including a machine-code representation and a control flow model of an application can be generated by a developer or distributor of the application using a source-code representation of the application. Thus, the generation of such a file can be independent of application monitoring performed by a user (e.g., with an application monitoring system as discussed herein) of the application.

Moreover, because the application as distributed to users (e.g., an executable file including a machine-code representation of the application and a control flow model of the application) includes a control flow model of the application, such users need not attempt to derive control flow information from, for example, a machine-code representation of the application. Rather, the user of the application can rely on the control flow model provided with the application and reliably and accurately derived from a source-code representation of the application.

Referring specifically to the example illustrated in FIG. 6, source-code representation 611 is a description of an application in a programming language, and is accessed by compiler 620 to generate machine-code representation 631 of the application. In other words, compiler 620 compiles and, in some implementations, performs additional operations such as preprocessing and linking to generate machine-code representation 631 of the application from source-code representation 611 of the application.

Additionally, control flow analyzer module 640 also accesses source-code representation 611. Control flow analyzer module 640 is a combination of hardware and software that analyzes a source-code representation of an application and generates a control flow model of the application. For example, control flow analyzer module 640 can be a component of a compilation system including compiler 620 that generates a control flow graph of the application (or one or more portions thereof) defined by source-code representation 611. Said differently, control flow analyzer module 640 performs control flow analysis of the application defined by source-code representation 611 to generate a control flow model of that application.

As an example, control flow information may be extracted by an application that operates in a similar fashion to the initial phases of a modern compiler. A compiler accesses source code and applies layered translations to obtain target object code. This translation process initially applies parsing techniques to produce an intermediate form, in a structure commonly known as an intermediate language that is typically compiler-specific. This intermediate language form is then used for optimization phases followed by typically translating into a target processor-specific symbolic assembler format. This is often referred to as the assembly phase. This symbolic assembler formatted code is then finally transformed into processor-specific binary machine code format to form the final object code. The control-flow information can be extracted as a secondary output from either the intermediate language code representation or from the assembly phase by reanalyzing the symbolic assembly code format. The control flow information produced then delineates the structural jump information which permits functional code and the basic blocks (or basic code blocks) to be fully identified. Such control flow information provides a mapping of how control is transferred between these basic blocks and functions (e.g. loop and recursion structure).

In some implementations, control flow analyzer module 640 also accesses machine-code representation 631 to identify sections of machine-code representation 631 that correspond to (e.g., define) basic blocks of the application represented by nodes of a control flow graph. For example, values representing byte offsets of sections of those sections of machine-code representation 631 that correspond to basic blocks of the application represented by nodes of the control flow graph can be stored at those nodes.

Control flow model 651 describes the flow (e.g., functionality or control flow) of the application defined by source-code representation 611 and is generated at control flow analyzer module 640. Control flow packager module 660 accesses control flow model 651 and machine-code representation 631 and generates file 671 including machine-code representation 631 (or a copy thereof) and a representation of control flow model 651. For example, machine-code representation 631 can be stored within one section or segment of an executable file (e.g., file 671) and control flow model 651 can be stored within another section or segment of the executable file.

In some implementations, control flow packager module 660 stores machine-code representation 631 within file 671 a binary representation (i.e., is properly interpreted as a sequences of one and zero values) and stores control flow model 651 within file 671 as a representation other than a binary representation. For example, control flow model 651 can be represented within file 671 as a flat textual description of control flow model 651, as a markup document such as an Extensible Markup Language (XML) document, as an object representation such as a JavaScript Object Notation (JSON) object, or as some other representation. In other words, machine-code representation 631 can be stored within one portion (e.g., section or segment) of file 671 with one format (e.g., a binary format), and control flow model 651 can be represented within another portion of file 671 with another format.

File 671 can then be stored at data store 690. Data store 690 is a non-volatile or persistent processor-readable medium. As a specific example, data store 690 can be a disk drive such a hard disk drive or a solid-state drive which is formatted with a file system within which file 671 is stored.

Furthermore, in some implementations, control flow packager module 660 encrypts the representation of control flow model 651 included in file 671. For example, control flow packager module 660 encrypts the representation of control flow model 651 included in file 671 using a symmetric or asymmetric cryptographic key. Moreover, in some implementations, control flow packager module 660 generates a digital signature of the representation of control flow model 651 included in file 671, and includes the digital signature and/or a digital certificate for authentication or validation of the digital signature in file 671.

File 671, or more specifically control flow model 651 included in file 671, can he used to perform a variety of analyses of the application represented by the file. For example, a user (e.g., an organization hosting the application at a computing system) can use an application monitoring system as discussed in various examples herein to provide application monitoring such as run-time monitoring of the application. As other example, such a user (e.g., using an application monitoring system) can use control flow model 651 to perform static analysis and review of the application based on information about the application included within control flow model 651. As another example, control flow model 651 can be used within an application monitoring system to perform run-time, dynamic analysis of the application. As a specific example, control flow model 651 can be used within an application monitoring system or other system or by a user or security analyst to perform security risk assessment on the application based on the information about the application included within control flow model 651.

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. As another example, functionalities discussed above in relation to specific modules or elements can be included at different modules, engines, or components in other implementations. Furthermore, it should be understood that the systems, apparatus, and methods described herein can include various combinations and/or sub-combinations of the components and/or features of the different implementations described. Thus, features described with reference to one or more implementations can be combined with other implementations described herein.

As used herein, the singular forms “a,” “an,” and “the” include plural referents unless the context clearly dictates otherwise. Thus, for example, the term “module” is intended to mean one or more modules or a combination of modules. Furthermore, as used herein, the term “based on” means “based at least in part on.” Thus, a feature that is described as based on some cause, can be based only on the cause, or based on that cause and on one or more other causes.

What is claimed is:

1. A processor-readable medium storing code representing instructions that when executed at a processor cause the processor to:
access a source-code representation of an application;
access a machine-code representation of the application;
generate a control flow model of the application based on the source-code representation of the application; and
store a representation of the control flow model within a file including the machine-code representation of the application.

2. The processor-readable medium of claim 1, wherein the control flow model includes references to the portions of the machine-code representation.

3. The processor-readable medium of claim 1, further comprising code representing instructions that when executed at the processor cause the processor to:
generate the machine-code representation of the application from the source-code representation of the application.

4. The processor-readable medium of claim 1, wherein the control flow model is generated based on the source-code representation of the application and the machine-code representation of the application.

5. The processor-readable medium of claim 1, further comprising code representing instructions that when executed at the processor cause the processor to:
encrypt the control flow model to define the representation of the control flow model.

6. A application monitoring method, comprising:
identifying a representation of a control flow model of an application within a file including a machine-code representation of the application;
interpreting the control flow model to identify a plurality of monitorable sections of the machine-code representation of the application; and
selecting a monitorable section from the plurality of monitorable sections for run-time monitoring of the application.

7. The method of claim 6, further comprising:
determining that the representation of the control flow model is encrypted; and
decrypting the representation of the control flow model.

8. The method of claim 6, further comprising:
instrumenting the monitorable section from the plurality of monitorable sections within a memory for run-time monitoring of the application.

9. The method of claim 6, further comprising:
instrumenting the monitorable section from the plurality of monitorable sections within a guest operating system hosted via a hypervisor implementing a shadow stack for control flow integrity checking.

10. The method of claim 6, wherein the control flow model is a control flow graph of the application.

11. An application monitoring system, comprising:
a control flow module to access a representation of a control flow model of an application within a file including a machine-code representation of the application and to interpret the control flow model to identify a plurality of monitorable sections of the machine-code representation of the application; and
a monitor module to initiate run-time monitoring of the application based on the plurality of monitorable sections of the machine-code representation of the application.

12. The system of claim 11, wherein the representation of the control flow model is encrypted within the file, the system further comprising:
a cryptographic module to decrypt the representation of the control flow model.

13. The system of claim 11, wherein the file includes a binary section encapsulating the machine-code representation of the application and a metadata section encapsulating the representation of a control flow model.

14. The system of claim 11, wherein the monitor module instruments at monitorable section from the plurality of monitorable sections of the machine-code representation of the application at a member to initiate run-time monitoring of the application.

15. The system of claim 11, wherein the control flow model is a control flow graph of the application.
